(19) United States
(12) Patent Application Publication
(10) Pub. No.: US 2017/0066328 A1
(43) Pub. Date: Mar. 9, 2017

(54) APPARATUS AND METHOD FOR SHOWING FUEL MILEAGE MEASUREMENT IN VEHICLE

(71) Applicants: Hyundai Motor Company, Seoul (KR); Kia Motors Corporation, Seoul (KR)

(72) Inventor: Dong Pil Yoon, Incheon (KR)

(21) Appl. No.: 15/066,512

(22) Filed: Mar. 10, 2016

(30) Foreign Application Priority Data
Sep. 3, 2015 (KR) 10-2015-0124699

(51) Int. Cl. B60K 35/00; G01S 19/42; B60W 20/14; B60W 10/08; B60W 10/18

(52) U.S. Cl. CPC B60K 35/00; B60W 10/08; B60W 10/18; B60W 20/14; G01S 19/42; B60K 2350/1092

(57) ABSTRACT

An apparatus is provided for showing information related to fuel efficiency in a vehicle includes: a determination unit collecting at least one factor related to fuel efficiency including at least one of an estimated value from a fuel economy prediction device and a travel distance under a coasting drive state; a calculation unit obtaining a fuel efficiency ratio based on each factor and calculating a fuel gain and a fuel contribution for each factor to provide information for each factor; and a display unit displaying the information provided from the calculation unit.

### CROSS-REFERENCE TO RELATED APPLICATION

This application claims priority to and the benefit of Korean Patent Application No. 10-2015-0124699, filed on Sep. 3, 2015 in the Korean Intellectual Property Office, the disclosure of which is hereby incorporated by reference as if fully set forth herein.

### TECHNICAL FIELD

The disclosure relates generally to an apparatus and a method for showing fuel mileage measurement in vehicle, and more particularly to a device and a method, adapted in a vehicle, for showing plural fuel mileage information corresponding to a driving status or condition, so as to induce a driver to consider fuel efficiency while operating the vehicle.

### BACKGROUND

Generally, information related to fuel efficiency, which can be provided to a driver while she or he is driving, include a fuel efficiency ratio and/or an estimated value of remaining travel distance against remaining gas in a tank. Further, a method for providing the fuel efficiency ratio of vehicle in real-time can include a process of showing calculated average fuel efficiency based on an accumulated travel distance and an accumulated used gas amount and a process of showing an instant fuel consumption based on a travel distance and a used gas amount for a predetermined time (or period).

Eco-driving, which typically refers to smarter and more fuel-efficient driving techniques, has become a social issue because of several reasons such as use of fossil fuel, oil price, and so on. For coping with enhanced regulations to limit carbon dioxide emissions, plural techniques to improve fuel efficiency have been developed.

However, in a conventional method for showing fuel efficiency, it is difficult to quantitatively compare fuel efficiencies based on newly attempted techniques for improving fuel efficiency with each other (e.g., comparison between particular in-vehicle functions, devices, or operations for enhancing fuel efficiency). Since the driver assumes fuel efficiency based on her or his experience, e.g., average fuel efficiency and instant fuel consumption during a previous driving or operation, even when the vehicle includes plural advanced functions, devices or operations for enhancing fuel efficiency, plural techniques to improve fuel efficiency may have a low commercial value.

Particularly, with respect to an economy driving support system or an “Eco-guide,” a driver's confidence may be low. That is, because the driver no longer uses in-vehicle functions, devices, or operations for improving fuel efficiency when she or he cannot quantitatively know, or tangibly or empirically understand about fuel efficiency improvement, the in-vehicle functions, devices, or operations for enhancing fuel efficiency can effectively become an expensive white elephant.

### SUMMARY

An apparatus and a method for use in a vehicle provide comprehensive information of fuel efficiency calculated according to operating states of plural in-vehicle functions, devices, or operations and vehicle driving states or conditions, or selective information thereof according to a driver's or operator's request.

Further, an apparatus and a method for use in a vehicle analyze a real-time driving state, operating states of fuel efficiency functions, and in-vehicle devices or characteristics of fuel consumption for calculating a quantitative value (e.g., contribution of fuel efficiency and fuel gains) regarding how an analyzed subject has an effect on fuel efficiency, and providing, to a driver, calculated information about current/previous fuel efficiency and driving history a predetermined driving cycle via a device for information display and data output, so as to induce a driver to drive more fuel-efficiently or to use in-vehicle functions, devices or operations for fuel efficiency while operating the vehicle.

According to embodiments of the present disclosure, an apparatus for managing or showing information related to fuel efficiency in a vehicle includes: a determination unit collecting at least one factor related to fuel efficiency including at least one of an estimated value from a fuel economy prediction device and a travel distance under a coasting drive state; a calculation unit obtaining a fuel efficiency ratio based on each factor and calculating a fuel gain and a fuel contribution for each factor to provide information for each factor; and a display unit displaying the information provided from the calculation unit.

The fuel economy prediction device can estimate the fuel efficiency based on at least one of location information, distance information, and altitude information obtained by a global positioning system (GPS). The coasting drive state can include a period and a count of valid coasting drive, which are obtained by a coasting drive checking system.

The calculation unit can calculate a coasting drive rate, a coasting drive fuel gain, and a coasting drive fuel contribution based on the period and the count of valid coasting drive. Further, the calculation unit can calculate an energy prediction value, an energy management fuel gain and an energy management fuel contribution based on an estimated value delivered from the fuel economy prediction device.

The at least one factor includes at least one of an economical driving section according to an engine operating state of the vehicle, a section of electric vehicle (EV) mode when the vehicle is a hybrid electric vehicle (HEV), and a regenerative breaking section, performed by a regenerative braking system (RBS) of the vehicle, in which kinetic energy is extracted from braking parts of the vehicle, to be stored and reused.

The calculation unit can calculate at least one of an eco-driving rate, an eco-driving fuel gain, and an eco-driving fuel contribution based on the economical driving section, an EV rate, an EV fuel gain and an EV fuel contribution based on the section of EV mode, and an RBS rate, an RBS fuel gain, and an RBS fuel contribution based on the regenerative breaking section.

The at least one factor can further include a period and a count of the regenerative breaking section checked by a regenerative breaking guidance device. The calculation unit can calculate an RBS rate, an RBS fuel gain and an RBS fuel contribution based on the period and the count of the regenerative breaking section.

The at least one factor can further includes at least one of: a fuel usage consumed in at least one of an operating state of an electronic system, an ignition state, and a driving state of the vehicle based on information provided from a navigation device, and an accumulated travel distance, a real-time fuel consumption and an accumulated fuel consumption according to an operation state of the vehicle for a predetermined time.

The calculation unit can calculate a total travel distance, a total average speed and a total average fuel efficiency according to the at least one factor.

The display unit can use at least one of: and instrument panel on a dashboard of the vehicle and a screen engaged with a multimedia system of the vehicle. The display unit can selectively show at least one of each information calculated by the calculation unit and comprehensive information based on the calculated information in response to a request of the driver.

The apparatus can further include a transceiver transferring the calculated information delivered from the calculation unit via a network.

The calculation unit can receive a gas price through the transceiver and apply the gas price to each calculated information and comprehensive information based on the calculated information so as to obtain fuel costs regarding each calculated information and the comprehensive information. The display unit can show the fuel costs in response to a request of the driver.

The apparatus can further include a memory storing the calculated information for each factor provided from the calculation unit and storing history/tracking information delivered through a transceiver.

Furthermore, according to embodiments of the present disclosure, a network apparatus engaged with a vehicle for managing fuel efficiency includes: a receiving unit receiving vehicle information, calculated information, and comprehensive information for at least one factor related to fuel efficiency including at least one of an estimated value and a travel distance under a coasting drive state; a data storing unit storing the information received by the receiving unit; a data processing unit searching for information stored in the data storing unit in response to a request received by the receiving unit and processing information identified in the data storing unit; and a transmitting unit transmitting a result processed by the data processing unit.

Further, the transmitting unit transmits a price of gas corresponding to the vehicle information via a network.

The at least one factor can include: an economical driving section according to an engine operating state of the vehicle, a section of electric vehicle (EV) mode when the vehicle is a hybrid electric vehicle (HEV), a regenerative breaking section, performed by a regenerative braking system (RBS) of the vehicle, in which kinetic energy is extracted from braking parts of the vehicle, to be stored and reused, a period and a count of the regenerative breaking section checked by a regenerative breaking guidance device, a fuel usage consumed in at least one of an operating state of an electronic system, an ignition state, and a driving state of the vehicle based on information provided from a navigation device, and an accumulated travel distance, a real-time fuel consumption, and an accumulated fuel consumption according to an operation state of the vehicle for a predetermined time.

Furthermore, according to embodiments of the present disclosure, an apparatus is provided for showing information related to fuel efficiency of vehicle engaged with a network-linkable device comprising a processing system that includes at least one data processor and at least one computer-readable memory storing a computer program executable by the at least one data processor. The processing system is configured to cause the apparatus to: recognize at least one factor related to fuel efficiency including at least one of an estimated value from a fuel economy prediction device and a travel distance under a coasting drive state; obtain a fuel efficiency ratio based on each factor, a fuel gain and a fuel contribution for each factor, and calculated information for each factor; and display the obtained information in response to a request of a driver.

The processing system can be further configured to cause the apparatus to transmit the obtained information and comprehensive information based on the calculated information via a network link.

The processing system can be further configured to cause the apparatus to store the obtained information for each factor, which are obtained while the vehicle operates, and history/tracking information delivered via a network link.

The processing system can be further configured to cause the apparatus to determine a driving route to a destination, to activate at least one of a coasting drive checking system and a fuel economy prediction device, while the vehicle operates on the driving route, and to recognize at least one of a travel distance while coasting through the coasting drive checking system and a gain of state of charge (SOC) through the fuel economy prediction device.

The processing system can be further configured to cause the apparatus to collect information including at least one of fuel consumption during the travel distance while coasting and available gains of state of charge (SOC) while the fuel economy prediction device is enabled, to calculate the fuel gain based on the collected information, to combine the fuel gain with previous fuel gain, to estimate fuel efficiency based on the driving route and the collected information, to calculate mileage gain based on combined fuel gain and estimated fuel efficiency, and to calculate fuel contribution for each collected information based on the calculated fuel gain and the combined fuel gain.

Advantages, objects, and features of the present disclosure will be set forth in part in the description which follows and in part will become apparent to those having ordinary skill in the art upon examination of the following or may be learned from practice of the disclosed embodiments. The objectives and other advantages of the disclosure may be realized and attained by the structure particularly pointed out in the written description and claims hereof as well as the appended drawings.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 shows an in-vehicle device for showing fuel efficiency, which is engaged with network devices;

FIG. 2 describes a determination unit shown in FIG. 1;

FIG. 3 shows a calculation unit shown in FIG. 1;

FIG. 4 shows a method for calculating fuel gain and fuel contribution at the calculation unit shown in FIG. 3;

FIG. 5 describes a display unit shown in FIG. 1;

FIG. 6 shows an interface of in-vehicle fuel efficiency display device;

FIG. 7 describes a method for showing fuel efficiency in a vehicle;

FIG. 8 shows a method for calculating fuel gain and fuel contribution based on a coasting drive state;

FIG. 9 shows a method for calculating fuel gain and fuel contribution based on an energy management device;

FIG. 10 shows fuel gain and fuel contribution improved according to a particular function, device, or operation state;

FIG. 11 shows fuel gain and fuel contribution improved according to another particular function, device, or operation state; and

FIG. 12 shows accumulated average fuel efficiency and fuel contribution based on the coasting drive state and the fuel economy prediction device.

### DETAILED DESCRIPTION OF THE EMBODIMENTS

Reference will now be made in detail to the embodiments of the disclosure, examples of which are illustrated in the accompanying drawings. In the drawings, the same elements are denoted by the same reference numerals, and a repeated explanation thereof will not be given. The suffixes “module” and “unit” of elements herein are used for convenience of description and thus can be used interchangeably and do not have any distinguishable meanings or functions.

The terms “a” or “an”, as used herein, are defined as one or more than one. The term “another”, as used herein, is defined as at least a second or more. The terms “including” and/or “having” as used herein, are defined as comprising (i.e., open transition). The term “coupled” or “operatively coupled” as used herein, is defined as connected, although not necessarily directly, and not necessarily mechanically.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one processor specifically programmed to execute program instructions stored in a memory to perform one or more processes which are described further below. Moreover, it is understood that the below methods may be executed by an apparatus comprising the processor(s) and memory in conjunction with one or more other components, as would be appreciated by a person of ordinary skill in the art.

In the description of the disclosure, certain detailed explanations of related art are omitted when it is deemed that they may unnecessarily obscure the essence of the present disclosure. The features of the disclosure will be more clearly understood from the accompanying drawings and should not be limited by the accompanying drawings. It is to be appreciated that all changes, equivalents, and substitutes that do not depart from the spirit and technical scope of the disclosure are encompassed in the disclosure.

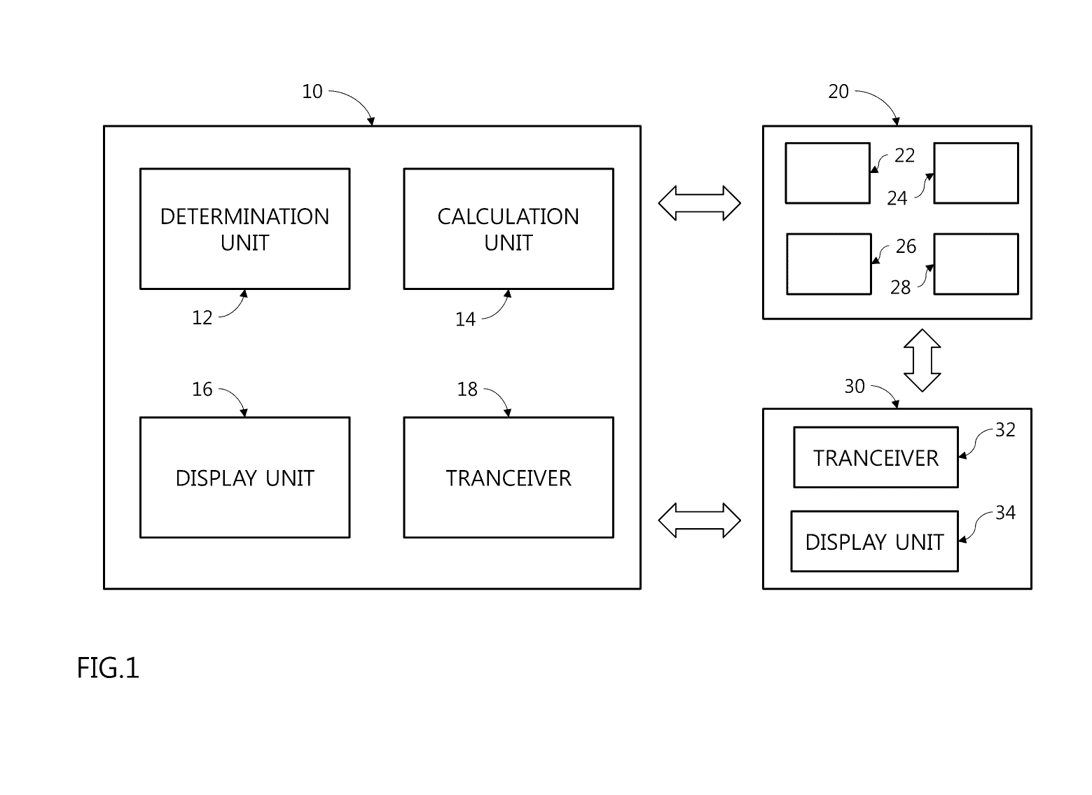

FIG. 1 shows an in-vehicle device for showing fuel efficiency, which is engaged with network devices.

As shown, an in-vehicle fuel management device 10 can be engaged with a network server 20 and a mobile device 30 via a wired/wireless network.

The in-vehicle fuel management device 10 can include a determination unit 12, a calculation unit 14, and a display unit 16. The determination unit 12 can collect a factor related to fuel efficiency including at least one of an estimated value from a fuel economy prediction device and a travel distance under a coasting drive state (i.e., while the vehicle is coasting). Herein, the fuel economy prediction device is a kind of apparatus used extensively to predict both the instantaneous and total fuel consumption of a vehicle system over a specified operational cycle. The fuel economy prediction device can be included in a vehicle or engaged with a vehicle via a network. Also, the coasting drive state is a sort of driving (i.e., operation) mode when a vehicle uses an alternative to acceleration or braking is coasting, i.e., gliding along without propulsion. Further, the calculation unit 14 can calculate a fuel efficiency ratio based on the factor. The calculation unit 14 can also calculate a fuel gain and a fuel contribution for each factor so as to provide calculated information for each factor and comprehensive information based on the calculated information. The display unit 16 can display information provided from the calculation unit 14.

The determination unit 12 can be engaged with plural devices and systems included in the vehicle, which can assist or control vehicle operations related to the fuel consumption or efficiency. For example, The fuel economy prediction device (not shown in FIG. 1) engaged with the determination unit can estimate fuel efficiency based on at least one location information, distance information, and altitude information obtained by a global positioning system (GPS). For estimating fuel efficiency, the fuel economy prediction device can uses map information regarding a driving route provided from a navigation device included in, or engaged with, the vehicle. Based on the map information, the fuel economy prediction device can use a road curvature and a road gradient, i.e., the steepness of a section of road, to predict fuel efficiency on a driving route selected by a driver. The determination unit 12 can deliver the value estimated by the fuel economy prediction device into the calculation unit 14.

Further, the determination unit 12 can recognize whether a vehicle operates in a coasting drive mode. Coasting can dissipate stored energy (e.g., kinetic energy and gravitational potential energy) against aerodynamic drag and rolling resistance which can always be overcome by the vehicle during travel. For the way of example but not limitation, a coasting drive checking system can inform a driver that, on a downhill road, a vehicle can operate without fuel consumption when a driver don't step on a gas pedal (i.e., accelerator). Through the coasting drive checking system, the determination unit 12 can collect a period and a count of valid coasting drive, and transfer collected information about the period and the count into the calculation unit 14.

Based on the period and the count of valid coasting drive, the calculation unit 14 can calculate a coasting drive rate, a coasting drive fuel gain and a coasting drive fuel contribution. Further, the calculation unit 14 can be capable of obtaining an energy prediction value, an energy management fuel gain and an energy management fuel contribution, based on the delivered value estimated by the fuel economy prediction device.

The factor related to fuel efficiency, which is collected by the determination unit 12, contains a wide variety. For the way of example but not limitation, the factor can include at least one of an economical driving section according to an engine operating state, a section of electric vehicle (EV) mode when the vehicle is a hybrid electric vehicle (HEV), and a regenerative breaking section, performed by a regenerative braking system (RBS), in which kinetic energy is extracted from the parts braked, to be stored and reused, and the like. The factor recognized by the determination unit 12 can be different according to devices or systems included in, or engaged with, the vehicle.

The calculation unit 14 can calculate a fuel gain, a fuel contribution, or the like for each factor delivered from the determination unit 12. For the way of example but not limitation, the calculation unit 14 can calculate at least one of an eco-driving rate, an eco-driving fuel gain and an eco-driving fuel contribution based on the economical driving section, an EV rate, an EV fuel gain and an EV fuel contribution based on the section of EV mode, and an RBS rate, an RBS fuel gain, and an RBS fuel contribution based on the regenerative breaking section.

For example, when a vehicle includes a regenerative breaking guidance device, the determination unit 12 can collect, or recognize, a period and a count of the regenerative breaking section checked by the regenerative breaking guidance device. In this case, the calculation unit 14 can calculate an RBS rate, an RBS fuel gain and an RBS fuel contribution based on the period and the count of the regenerative breaking section.

Further, the determination unit 12 can recognize a fuel usage consumed in at least one of an operating state of electronic system, an ignition state, and a driving state based on information provided from a navigation device as well as an accumulated travel distance, a real-time fuel consumption and an accumulated fuel consumption according to an operation state for a predetermined time. For example, the predetermined time can be determined by a driver. According to the recognized factor, the calculation unit 14 can calculate a total travel distance, a total average speed, total average fuel efficiency, and so on.

The display unit 16 can use instrument panel on a dashboard and/or a screen engaged with a multimedia system so as to selectively shows each information calculated by the calculation unit 14 and/or comprehensive information based on the calculated information in response to a request of a driver.

The in-vehicle fuel management device 10 can further include a transceiver 18 configured to transfer the calculated information delivered from the calculation unit 14 via a network. Further, when engaged with network devices through the transceiver 18, the in-vehicle fuel management device 10 can provide plural, more diverse, information to a driver.

For example, when receiving a gas price through the transceiver 18, the calculation unit 14 can apply the gas price to each of calculated information and the comprehensive information so as to obtain fuel saving costs regarding each of calculated information and the comprehensive information. The display unit can show the fuel saving costs in response to driver's request. Since a driver is more sensitive to fuel saving costs than fuel saving efficiency or fuel saving amount, this function based on the gas price can have an advantage of providing more intuitive information to a driver.

The network server 20 can be engaged with the in-vehicle fuel management device 10 included in the vehicle for managing fuel efficiency. The network server 20 can include a receiving unit 22 configured to receive vehicle information, calculated information and comprehensive information for at least one factor related to fuel efficiency. Herein, the factor can include at least one of an estimated value and a travel distance under a coasting drive state. In the network server 20, a data storing unit 24 can store delivered information through the receiving unit 22, and a data processing unit 26 can search for information stored in the data storing unit 24 in response to a request delivered through the receiving unit 22. The network server 20 can further include a transmitting unit 28 configured to transmit a result processed by the data processing unit 26.

Further, the transmitting unit 28 can transmit a price of gas corresponding to the vehicle information via a network. For the way of example but not limitation, in response to the vehicle information delivered into the network server 20, the transmitting unit 28 can transfer price information of gas such as a gasoline, a diesel, a liquefied petroleum gas (LPG), which is used in the vehicle, into the in-vehicle fuel management device 10.

The mobile device 30 can be engaged with the in-vehicle fuel management device 10 and/or the network server 30 via a wired/wireless network. The mobile device 30 can include a transceiver 32 configured to receive information delivered from at least one of the in-vehicle fuel management device 10 and the network server 30. The information received through the transceiver 32 can include a fuel efficiency ratio based on at least one factor, a fuel gain, and a fuel contribution for each factor, calculated information for each factor and comprehensive information based on the calculated information. The factor can include an estimated value from the fuel economy prediction device, a travel distance under a coasting drive state, and the like. Further, the mobile device 30 can include a display unit 34 configured to show information delivered through the transceiver 32 in response to driver's request.

Further, the transceiver 32 can receive calculated information for the factor while the vehicle operates, as well as history/tracking information. Information delivered via the transceiver 32 can be shown by the display unit 34 in response to user's request.

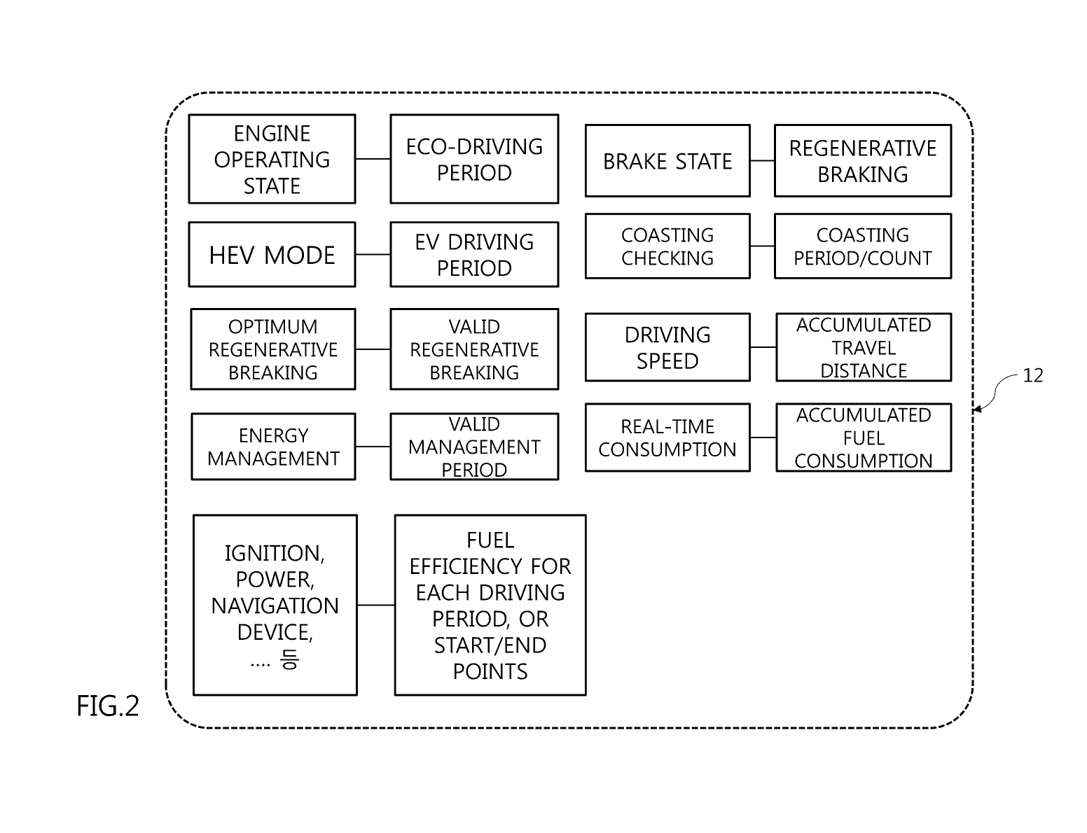

FIG. 2 describes the determination unit 12 shown in FIG. 1.

As shown, the determination unit 12 can recognize, or collect, plural vehicle states related to fuel efficiency and information obtained by plural functions, devices or operations included in, or engaged with, the vehicle. The vehicle states and the obtained information can be different according to the functions, the devices or the operations included in, or engaged with, the vehicle.

By the way of example but not limitation, the vehicle states and the information gathered by the determination unit 12 can include an economical driving section according to an engine operating state, a section of EV mode when the vehicle is a HEV, a regenerative breaking section, performed by a RBS, in which kinetic energy is extracted from the parts braked, to be stored and reused, a period and a count of the regenerative breaking section checked by the regenerative breaking guidance device, a fuel usage consumed in at least one of an operating state of electronic system, an ignition state, and a driving state based on information provided from a navigation device, an accumulated travel distance, an real-time fuel consumption and an accumulated fuel consumption according to an operation state for a predetermined time, and the like.

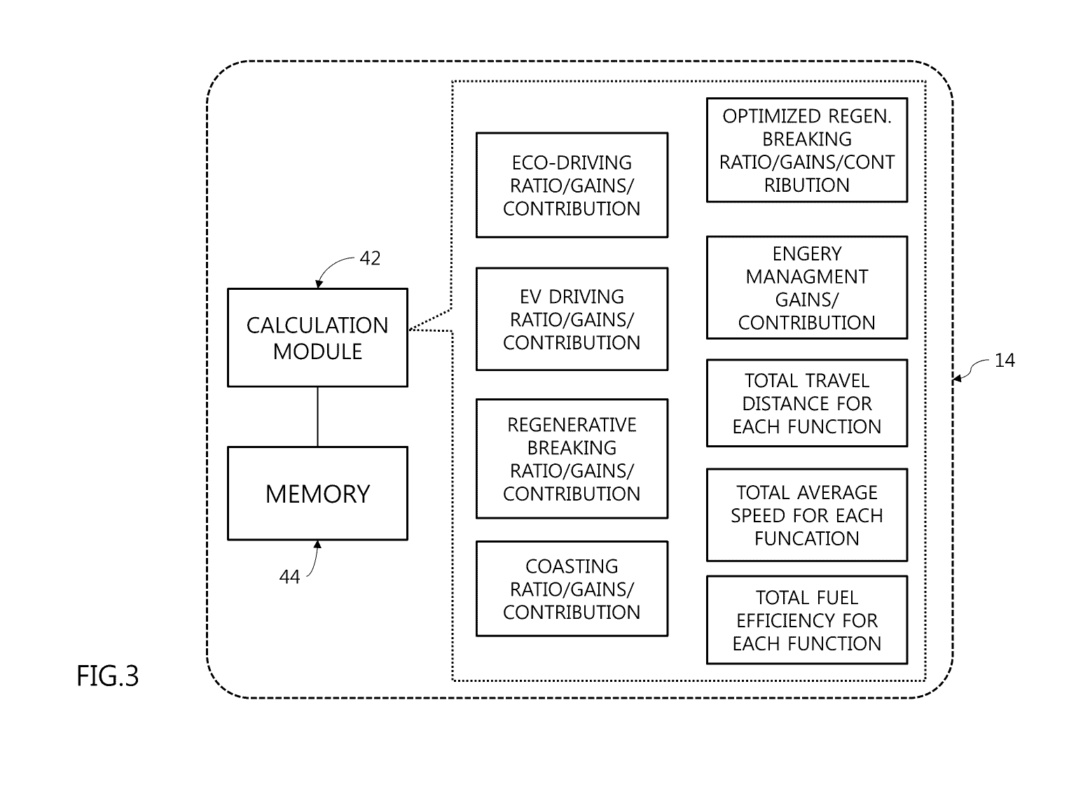

FIG. 3 shows the calculation unit 14 shown in FIG. 1.

As shown, the calculation unit 14 can include a calculating module 42 and a memory 44. The calculating module 42 can calculate a ratio, a gain, and/or a contribution for each factor collected by the determination unit 12. The memory 44 can store the calculated information for the factor, which are provided from the calculation module 42, as well as history/tracking information delivered through the transceiver 18.

By the way of example but not limitation, the calculation module 42 can produce a coasting drive rate, a coasting drive fuel gain and a coasting drive fuel contribution based on the period and the count of valid coasting drive, an energy prediction value, an energy management fuel gain and an energy management fuel contribution based on an estimated value delivered from the fuel economy prediction device, an eco-driving rate, an eco-driving fuel gain and an eco-driving fuel contribution based on the economical driving section, an EV rate, an EV fuel gain and an EV fuel contribution based on the section of EV mode, and an RBS rate, an RBS fuel gain and an RBS fuel contribution based on the regenerative breaking section.

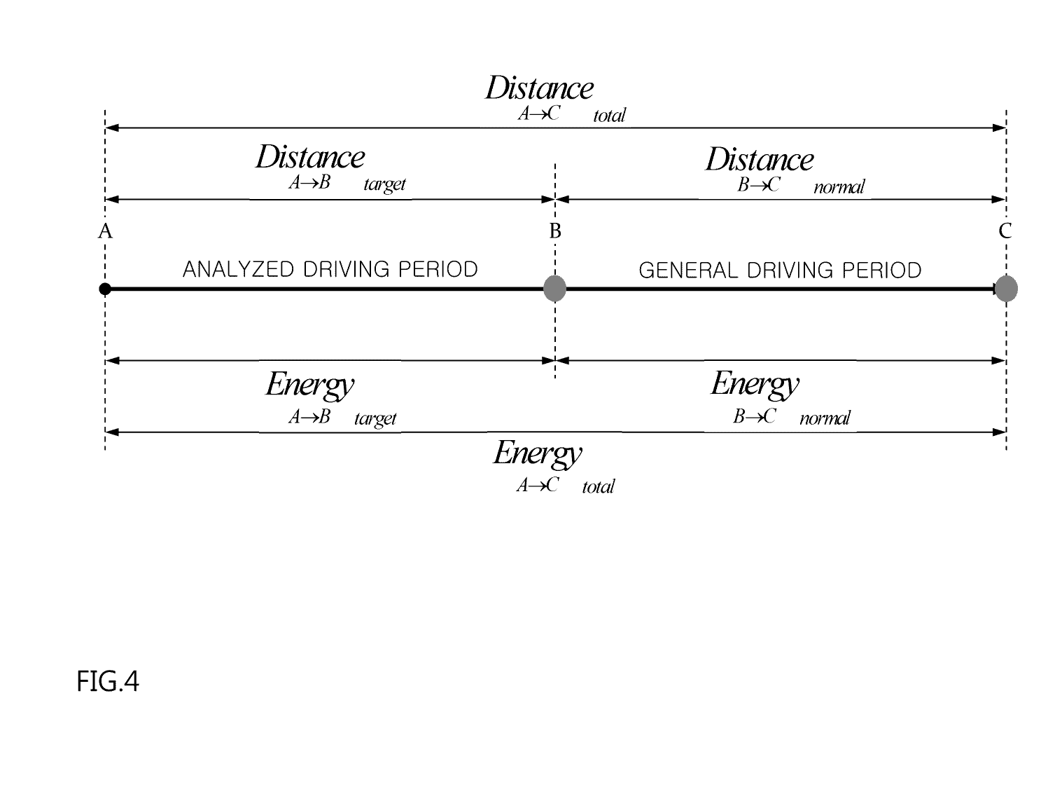

FIG. 4 shows a method for calculating fuel gain and fuel contribution at the calculation unit 14 shown in FIG. 3.

As shown, in order to calculate fuel gains and fuel contributions at the calculation unit 14, a total travel distance (Distance_{A→C total}) from a point A to a point C can be split into an analyzed driving period of first travel distance (Distance_{A→B target}) from the point A to a point B which can be determined or defined by each of functions, devices or operations included in, or engaged with, the vehicle, and a general driving period of second travel distance (Distance_{B→C normal}) from the point B to the point C in which the functions, the devices or the operations included in, or engaged with, the vehicle may not operate. A fuel gain and a fuel contribution for the analyzed driving period can be calculated based on the first travel distance (Distance_{A→B target}) and an energy consumption (Energy_{A→B target}).

By the way of example but not limitation, while a driver operates a vehicle, the analyzed driving period and the general driving period can be occurred repeatedly. If it is assumed that the driver has a coasting drive on a downhill road while she or he does not have a coasting drive on an uphill road, a section of coasting drive on a downhill can be considered the analyzed driving period, while a section of non-coasting drive can be considered the general driving period.

First, substantial fuel efficiency about the total travel distance from the point A to the point C including the analyzed driving period and the general driving period can be determined as follows.

$${E \text{/} E}_{A -> C total \_ actual} = ( \frac{{Distace}_{A -> C total}}{{Energy}_{A -> C total}} )$$

Then, substantial fuel efficiency about the analyzed driving period from the point A to the point B can be determined as follows.

$${E \text{/} E}_{A -> B target} = ( \frac{{Distace}_{A -> B target}}{{Energy}_{A -> B target}} )$$

Also, substantial fuel efficiency about the general driving period from the point B to the point C can be determined as follows.

$${E \text{/} E}_{B -> C normal} = ( \frac{{Distace}_{B -> C normal}}{{Energy}_{B -> C normal}} )$$

Further, estimated value regarding fuel efficiency for the general driving period can be determined as follows.

$${E \text{/} E}_{B -> C normal \_ est} = ( \frac{{Distace}_{A -> C total} - {Distace}_{A -> B target}}{{Energy}_{A -> C total} - {Energy}_{A -> B target}} )$$

Also, estimated value regarding fuel efficiency for the total travel distance from the point A to the point C can be determined as follows.

$${Energy}_{A -> C normal \_ est} = ( \frac{{Distace}_{A -> C total}}{{E \text{/} E}_{B -> C normal \_ est}} )$$

Then, fuel saving amounts, i.e., fuel gain, for the total travel distance from the point A to the point C can be determined as follows.

$${Energy Saving}_{A -> C target} = {Energy}_{A -> C normal \_ est} - {Energy}_{A -> C total}$$

Further, a fuel contribution about a factor related to fuel efficiency occurred during the analyzed driving period in the total travel distance from the point A to the point C can be determined as follows.

$$\begin{matrix}{E \text{/} E}_{A -> C target \_ contributio n} \\ [ \% ]\end{matrix} = ( \frac{{Energy Saving}_{A -> C target}}{{Energy}_{A -> C total}} ) or ( \frac{{E \text{/} E}_{A -> C total \_ actual}}{{E \text{/} E}_{A -> C normal \_ est}} ) 100$$

While a driver drives, the analyzed driving period and the general driving period can be occurred repeatedly. Thus, if a fuel gain and a fuel contribution can be obtained as above described, those can be applicable to a total driving route in which the driver operates a vehicle. A fuel gain for the total driving route can be determined as follows.

$$\begin{matrix}{EnergySaving}_{target} \\ [ Liter ]\end{matrix} = ( \frac{{Σ}_{total}^{Distace} \cdot ( {Σ}_{total}^{Energy} - {Σ}_{target}^{Energy} )}{{Σ}_{total}^{Distace} - {Σ}_{target}^{Distace}} ) - {Σ}_{total}^{Energy}$$

Likewise, a fuel contribution for the total driving route can be determined as follows.

$$\begin{matrix}E \text{/} {E}_{target \_ contributio n} \\ [ \% ]\end{matrix} = ( \frac{{Σ}_{total}^{Energy} \cdot ( {Σ}_{total}^{Energy} - {Σ}_{target}^{Energy} )}{{Σ}_{total}^{Distace} - {Σ}_{target}^{Distace}} ) - 1 ) 100$$

In above described method, while a fuel gain and a fuel contribution can be calculated based on a travel distance and an energy consumption amount during an analyzed driving period, the fuel gain and the fuel contribution can be obtained from an equivalent energy during an analyzed driving period.

By the way of example but not limitation, gasoline's density standard is approximately 0.8, which can be different according to temperature and generally vary within a range of 0.65 to 0.8. Combustion heat produced from gasoline is approximately 11,260 kcal/kg, but heat produced from electricity is approximately 860 kcal/kWh. Motor energy efficiency is approximately 0.85, which can be different based on motor's mechanical/electrical characteristics and a current operating line and generally ranges from 0.7 to 0.95. It can be assumed that engine efficiency of gasoline engine is 0.25. Battery capacity of the vehicle can be determined by a battery included in the vehicle. Above described values can be applicable to calculate gasoline equivalent fuel economy (e.g., miles per gallon (MPG)) as follows.

$$\begin{matrix}Gasoline Equivalent \\ Fuel Economy\end{matrix} = ( \frac{\begin{matrix}SOC \\ Gain\end{matrix} \begin{matrix}Motor Energy \\ Efficiency\end{matrix} \begin{matrix}Battery \\ Capacity\end{matrix} \begin{matrix}Electricity ' s \\ Heat\end{matrix}}{\begin{matrix}\begin{matrix}Gasoline \\ Combustion Heat\end{matrix} \begin{matrix}Gasoline \\ Density Standard\end{matrix} \\ \begin{matrix}Fuel Temperature \\ Correction Factor\end{matrix} \begin{matrix}Engine Efficiency \\ of Gasoline Engine\end{matrix}\end{matrix}} )$$

Further, it is assumed that gasoline equivalent fuel economy is 0.263 (liter), SOC gain is 50%, effective SOC gain is 43%, travel distance gain from the gasoline equivalent fuel economy is 3.944 km (when fuel efficiency is km/l). Above described values can be applicable to calculate a fuel gain as follows.

$$\begin{matrix}{EnergySaving}_{target} \\ [ Liter ]\end{matrix} = ( \frac{Σ \begin{matrix}SOC \\ {Gain}^{target}\end{matrix} \begin{matrix}Motor Energy \\ Efficiency\end{matrix} \begin{matrix}Battery \\ Capacity\end{matrix} \begin{matrix}Electricity ' s \\ Heat\end{matrix}}{\begin{matrix}\begin{matrix}Gasoline \\ Combustion Heat\end{matrix} \begin{matrix}Gasoline \\ Density Standard\end{matrix} \\ \begin{matrix}Fuel Temperature \\ Correction Factor\end{matrix} \begin{matrix}Engine Efficiency \\ of Gasoline Engine\end{matrix}\end{matrix}} )$$

Further, a fuel contribution can be determined as follows.

$$\begin{matrix}E \text{/} {E}_{target \_ contributio n} \\ [ \% ]\end{matrix} = ( \frac{{EnergySaving}_{target}}{{Energy}_{total}} ) 100$$

As mentioned above, regarding each of the factors related to fuel efficiency and delivered from the determination unit 12, the calculation unit 14 can calculate a fuel gain and a fuel contribution, and combine fuel gains and fuel contributions for each factor. The fuel gain and the fuel contribution can be calculated based on a travel distance and fuel consumption during an analyzed driving period, and obtained from an equivalent energy analysis during the analyzed driving period.

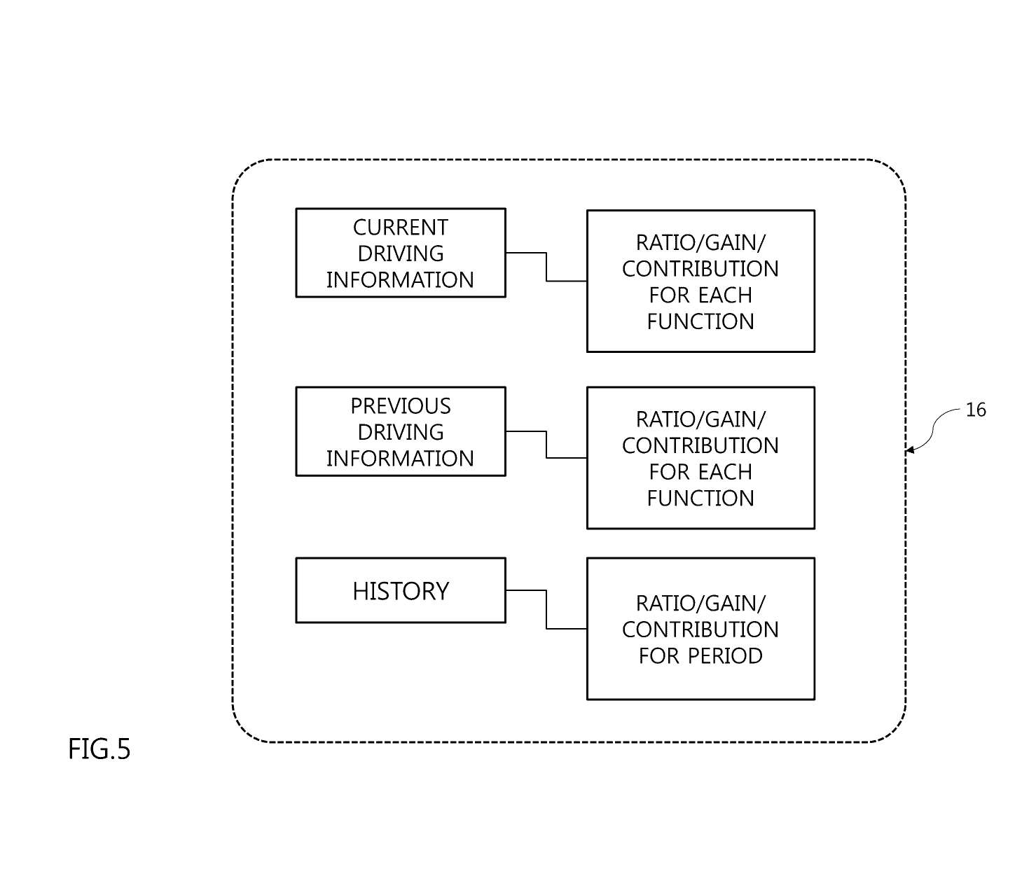

FIG. 5 describes the display unit 16 shown in FIG. 1.

As shown, the display unit 16 can show current driving information, previous driving information, history, and so on. Information provided by the display unit 16 can be different according to driver's request, as well as in response to which one of an instrument panel on a dashboard and a screen engaged with a multimedia system is used.

Particularly, the current driving information can include a run rate (ratio), a fuel gain, a fuel contribution, and the like for each function, device and operation included in the vehicle, while a driver operates the vehicle. Likewise, the previous driving information can contain a run rate (ratio), a fuel gain, a fuel contribution, and etc. for each function, device and operation included in the vehicle, while a driver operated in the past. Further, the history can include a run rate (ratio), a fuel gain, a fuel contribution, and etc. for each function, device and operation included in the vehicle, during a predetermined period such as one day, one week, one month, one quarter, one year, and so forth. The history can be delivered from the network server 20 engaged with the in-vehicle fuel management device 10.

Further, the information shown by the display unit 16 can be expressed in a different form such as a number, a bar shape, or the like.

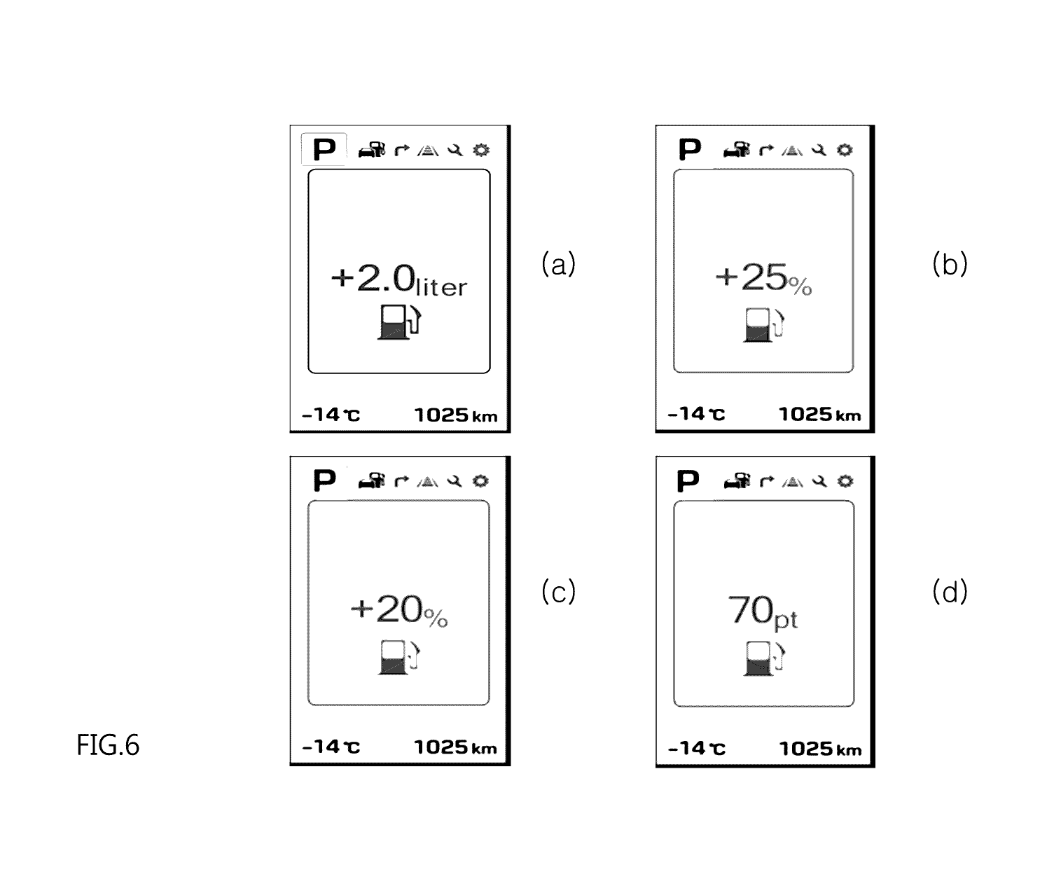

FIG. 6 shows an interface of in-vehicle fuel efficiency display device.

As shown, the interface of in-vehicle fuel efficiency display device can show plural information. In details, (a) shows a fuel gain, (b) describes a fuel contribution, (c) shows a fuel saving ratio, and (d) shows an eco-point. Herein, the fuel gain (unit: liter) and the fuel contribution (unit: %) can be obtained by above described methods shown in FIG. 4. The fuel saving ratio can be within 0 to 100%, which is a rate of energy saving based on the fuel gain and a fuel amount estimated without a fuel gain. The eco-point can be ranged of 0 to 100 pt, which is scored by a predetermined reference or standard so as to make a driver understand how his or her driving skill or habit affects, or improves, fuel efficiency.

Particularly, the fuel gain shown in (a) is a kind of direct and intuitive expression, which requires a high level reliability and accuracy. The fuel gain can be affected by a travel distance while a vehicle operates once. Further, the fuel contribution and the fuel saving ratio is a kind of indirect and intuitive expression, which requires a medium level reliability and accuracy. The fuel contribution and the fuel saving ration can be little affected by a travel distance while a vehicle operates once. The eco-point shown in (d) is a kind of indirect and abstract expression, which has a lower reliability. It can be little difficult for a driver to understand improvement of fuel efficiency through the eco-point.

Information shown in (a) to (d) of FIG. 6 are some examples expressed via the interface of in-vehicle fuel efficiency display device. The information can be different according driver's request or driver's setup information.

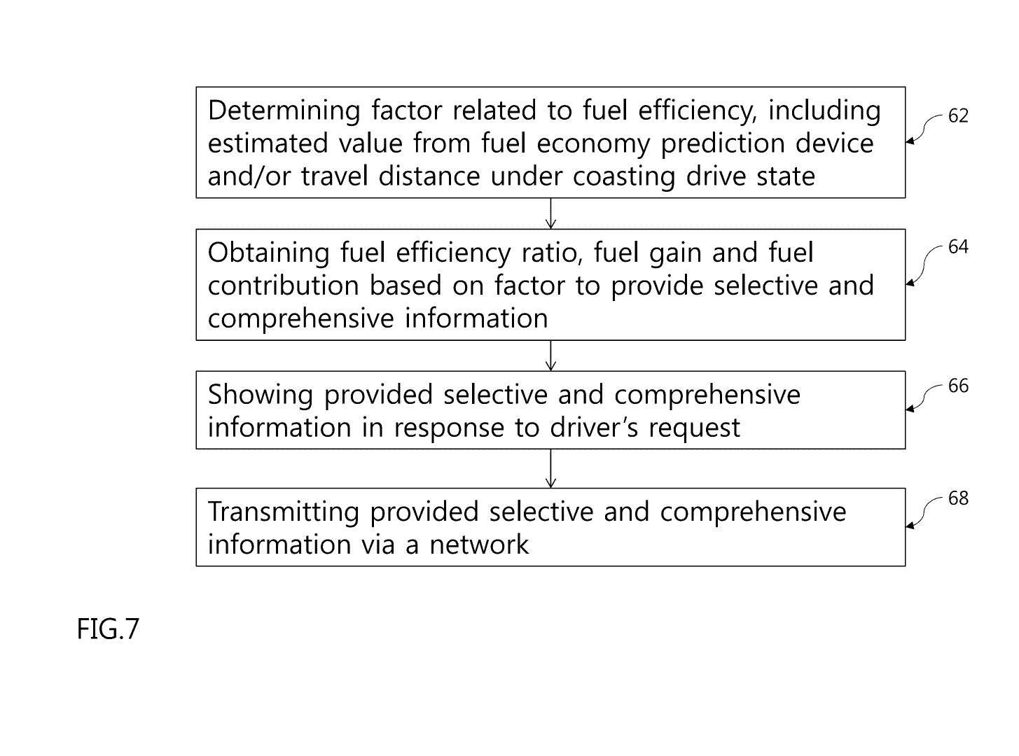

FIG. 7 describes a method for showing fuel efficiency in a vehicle.

As shown, the method for showing fuel efficiency can include determining a factor related to fuel efficiency (step 62), obtaining a fuel efficiency ratio, a fuel gain and a fuel contribution based on the factor to provide selective and comprehensive information (step 64), and showing provided selective and comprehensive information in response to driver's request (step 66). Herein, the factor can include at least one of an estimated value from a fuel economy prediction device and a travel distance under a coasting drive state. Further, the method can further include transmitting the provided selective and comprehensive information via a network (step 68).

By the way of example but not limitation, the factor related to fuel efficiency can include an economical driving section according to an engine operating state, a section of EV mode in a HEV, a regenerative breaking section, performed by a RBS, in which kinetic energy is extracted from the parts braked, to be stored and reused, a period and a count of the regenerative breaking section checked by the regenerative breaking guidance device, a fuel usage consumed in at least one of an operating state of electronic system, an ignition state, and a driving state based on information provided from a navigation device, an accumulated travel distance, a real-time fuel consumption and an accumulated fuel consumption according to an operation state for a predetermined time, and the like.

Further, the method for showing fuel efficiency can further include receiving a gas price, applying the gas price to each piece of selective and comprehensive information so as to obtain fuel costs regarding each calculated information and the comprehensive information, and showing obtained fuel costs in response to a request of a driver.

Further, the method for showing fuel efficiency can further include storing the calculated or obtained information for each factor as well as history/tracking information delivered through a network.

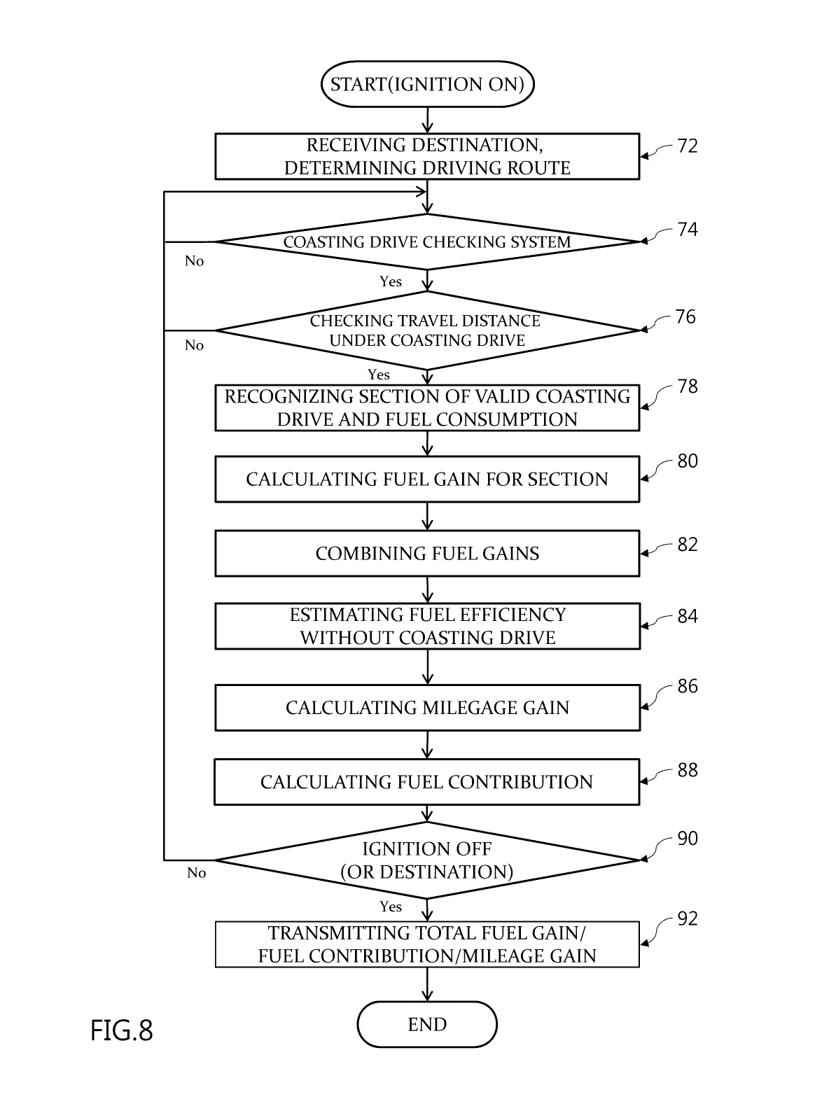

FIG. 8 shows a method for calculating fuel gain and fuel contribution based on a coasting drive state. In FIG. 8, it is assumed that a vehicle includes a coasting drive checking system.

As shown, the calculation method of fuel gain and fuel contribution can begin when an ignition of vehicle is turned on. The calculation method can include receiving a destination to determine a driving route from a current location to the destination (step 72), activating the coasting drive checking system while the vehicle operates on the driving route (step 74), and recognizing a travel distance of coasting drive through the coasting drive checking system (step 76). For example, if the coasting drive checking system is not enabled by a driver, or if the driver does not have a costing drive even when the coasting drive checking system is enabled, the calculation method does not proceed to the next step so as to calculate fuel gain or fuel contribution based on the coasting drive.

The calculation method can include, when the coasting drive checking system is activated and the driver has a coasting drive, recognizing a section of valid coasting drive and fuel consumption while the vehicle operates (step 78), calculating a fuel gain for the section based on recognized information (step 80), combining calculated fuel gain for the section with those for previous other sections (step 82), estimating fuel efficiency based on the driving route and the collected information (step 84), calculating mileage gain based on combined fuel gain and estimated fuel efficiency (step 86), and calculating fuel contribution for each collected information based on the calculated fuel gains and the combined fuel gain (step 88).

Above described processes can be performed until the ignition is turned off, or the vehicle arrives at the destination (step 90). For example, if the ignition is turned off, total fuel gain, fuel contribution, and/or mileage gain for a whole driving route can be transmitted via a network (step 92).

If the ignition is not turned off, the calculation method can performs the step of activating a coasting drive checking system while the vehicle operates on the driving route (step 74) and recognizing a travel distance of coasting drive through the coasting drive checking system (step 76). Then, the calculation processes can be proceeded repeatedly.

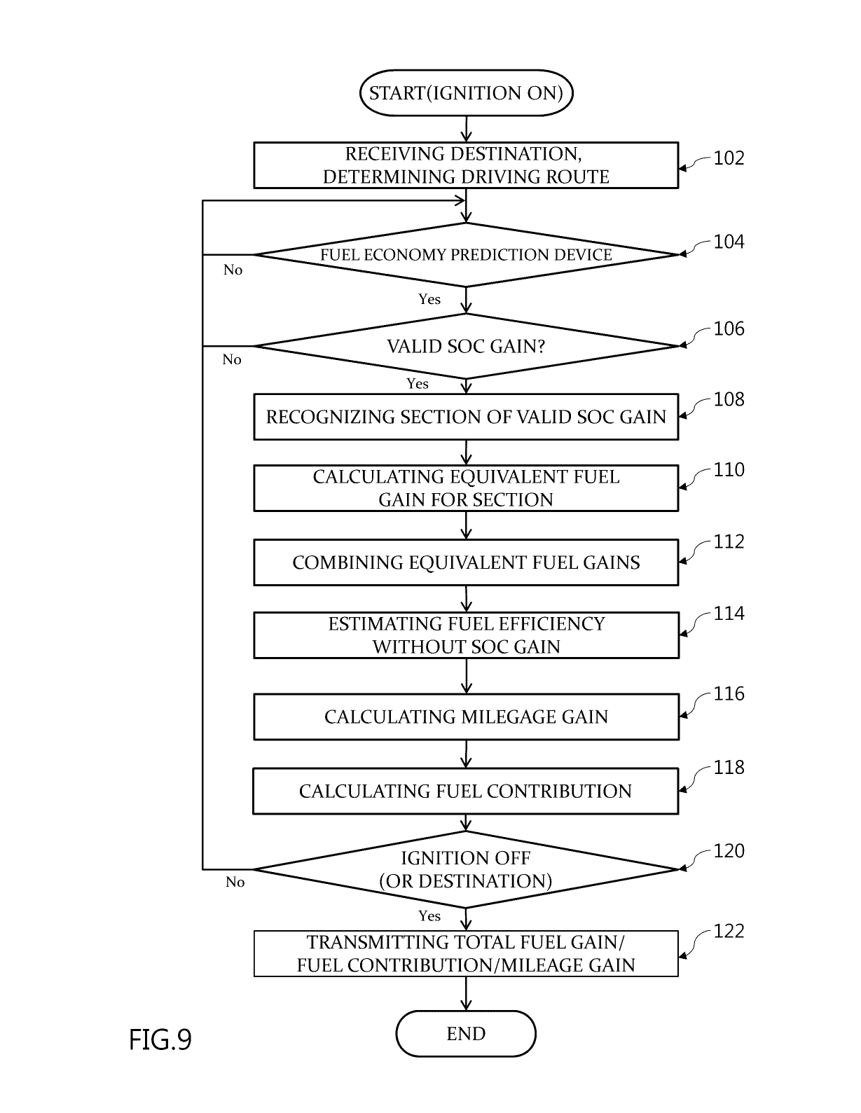

FIG. 9 shows a method for calculating fuel gain and fuel contribution based on an energy management device. In FIG. 9, it is assumed that a vehicle includes a fuel economy prediction device.

As shown, the calculation method of fuel gain and fuel contribution can begin when an ignition of vehicle is turned on. The calculation method can include receiving a destination to determine a driving route from a current location to the destination (step 102), activating the fuel economy prediction device while the vehicle operates on the driving route (step 104), and recognizing a valid SOC gain through the fuel economy prediction device (step 106). For example, if the fuel economy prediction device is not enabled by a driver, or if the driver does not have a valid SOC gain even when the fuel economy prediction device is enabled, the calculation method does not proceed to the next step so as to calculate fuel gain or fuel contribution which are obtainable from the fuel economy prediction device.

The calculation method can include, when the fuel economy prediction device is activated and the driver has a valid SOC gain, recognizing a section of valid SOC gain and fuel consumption while the vehicle operates (step 108), calculating an equivalent fuel gain for the section based on recognized information (step 110), combining calculated equivalent fuel gain for the section with those for previous other sections (step 112), estimating fuel efficiency based on the driving route and the collected information (step 114), calculating mileage gain based on combined equivalent fuel gain and estimated fuel efficiency (step 116), and calculating fuel contribution for each collected information based on the calculated equivalent fuel gains and the combined equivalent fuel gain (step 118).

Above described processes can be performed until the ignition is turned off, or the vehicle arrives at the destination (step 120). For example, if the ignition is turned off, total equivalent fuel gain, equivalent fuel contribution, and/or mileage gain for a whole driving route can be transmitted via a network (step 122).

If the ignition is not turned off, the calculation method can performs the step of activating the fuel economy prediction device while the vehicle operates on the driving route (step 104), and recognizing a valid state of charge (SOC) gain through the fuel economy prediction device (step 106). Then, the next calculation processes (steps 108 to 118) can be performed repeatedly.

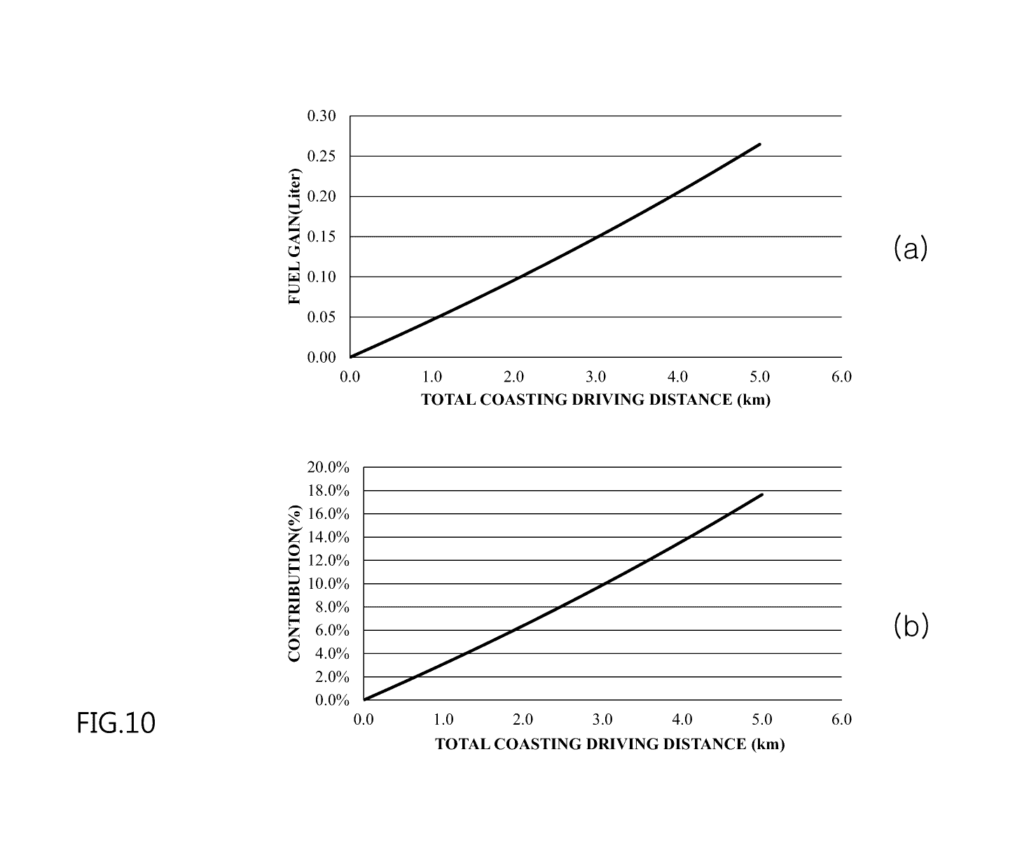

FIG. 10 shows fuel gain and fuel contribution improved according to a particular function, device, or operation state. In FIG. 10, it is assumed that a vehicle operates about 30 to 35 km a day and fuel efficiency is 15 km/l. In FIG. 10, (a) and (b) respectively describe simulation results regarding a fuel gain and a fuel contribution when an in-vehicle function or device such as a coasting drive checking system is used. As shown, the simulation results say that as a total coasting driving distance increases, the fuel gain and the fuel contribution increases.

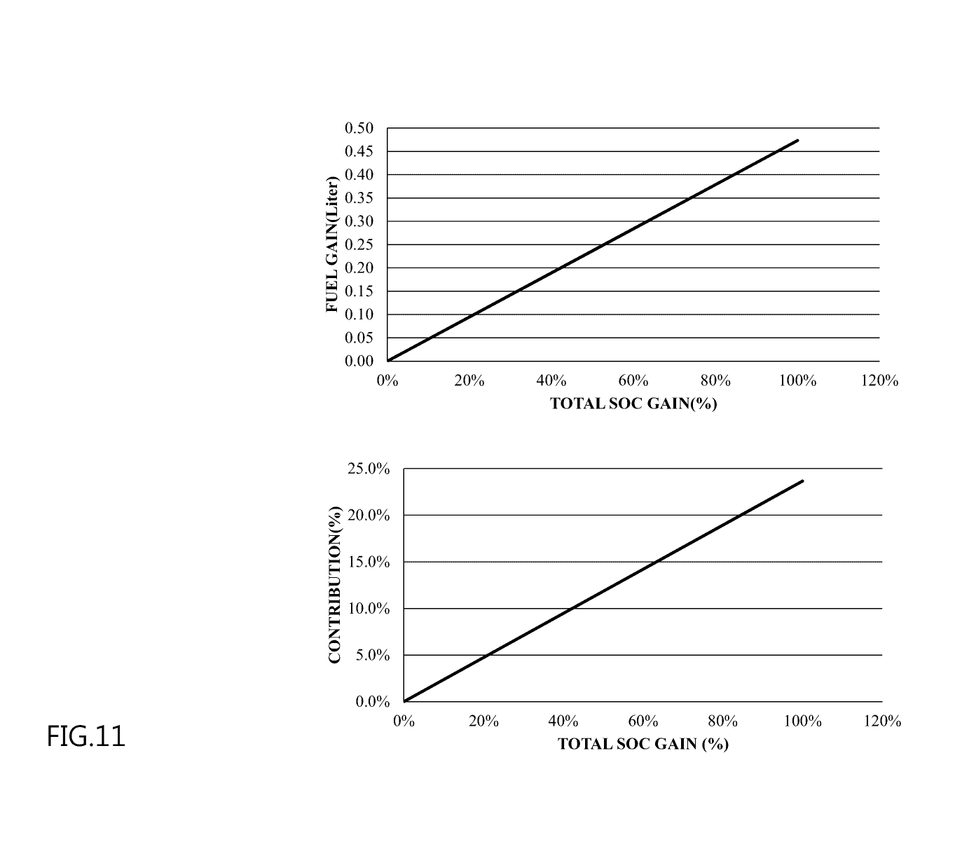

FIG. 11 shows fuel gain and fuel contribution improved according to another particular function, device, or operation state. In FIG. 10, it is assumed that a vehicle operates approximately 30 to 35 km a day and fuel efficiency is 15 km/l. In FIG. 10, (a) and (b) respectively describe simulation results regarding a fuel gain and a fuel contribution when an in-vehicle function or device such as a fuel economy prediction device is used. As shown, the simulation results say that as a total SOC gain increases, the fuel gain and the fuel contribution increases.

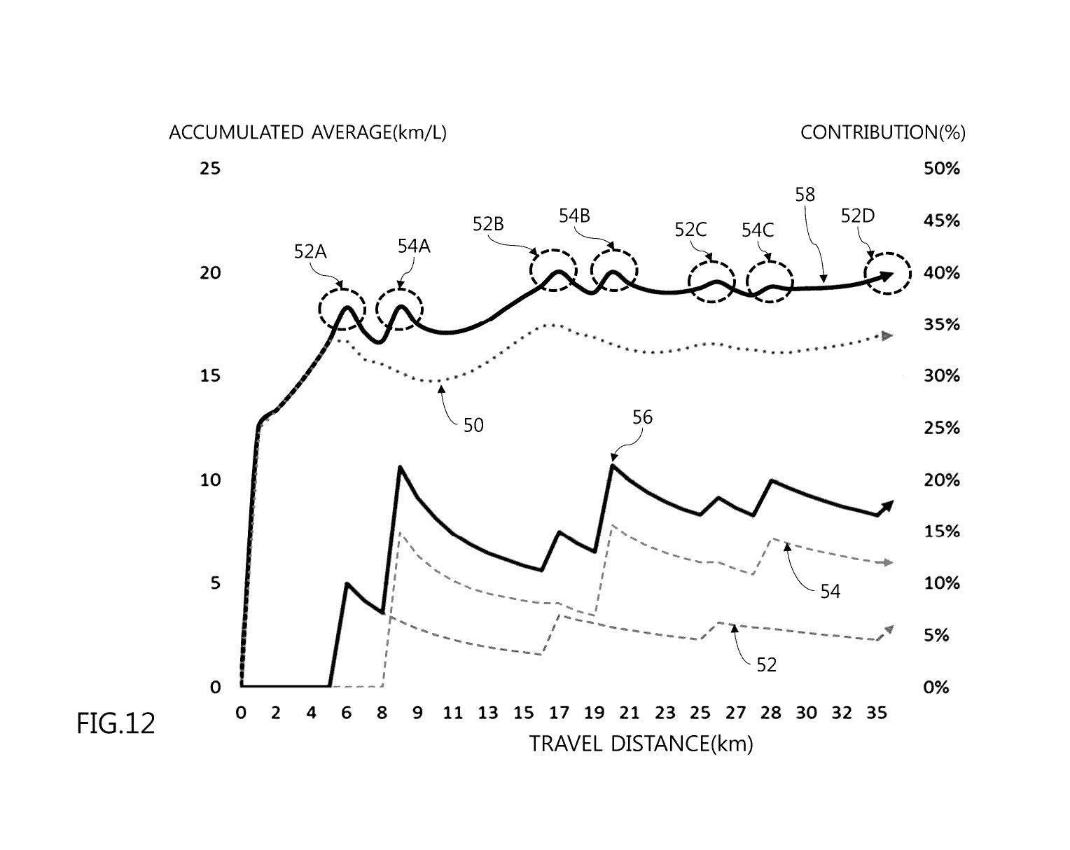

FIG. 12 shows accumulated average fuel efficiency and fuel contribution based on a coasting drive state and a fuel economy prediction device. In FIG. 12, it is assumed that an average daily travel distance is 35 km and an average fuel efficiency is 20 km/l. In combined effects on fuel efficiency based on sections of coasting drive and SOC gain, a fuel saving amount is approximately 0.316 liter, a fuel contribution is approximately 18.1%, and a mileage gain is approximately 5.36 km.

As shown, the simulation results show that fuel efficiency is improved from an accumulated average fuel efficiency of general driving 50 to a simulated average fuel efficiency 58 based on the coasting drive state and the fuel economy prediction device.

In detail, the simulated average fuel efficiency 58 can be affected by plural coasting drive sections 52A, 52B, 52C, 52D and plural energy prediction sections 54A, 54B, 54C. Fuel contributions 54, 56 for each of the coasting drive sections 52A, 52B, 52C, 52D and the energy prediction sections 54A, 54B, 54C can be calculated, and combined into the combined fuel contribution 56. These calculation can support the fuel efficiency improvement from the accumulated average fuel efficiency of general driving 50 to the simulated average fuel efficiency 58 based on the coasting drive state and the fuel economy prediction device.

As described above, when fuel gain and fuel contribution regarding factors/information obtained from functions, devices or operations included in a vehicle are calculated and calculated information is shown to a driver, the driver can put more confidence in provided information and fuel efficiency can be improved while the driver operates the vehicle.

When plural devices for use in a vehicle are developed, an in-vehicle fuel management device can be used for predicting or analyzing influence and effect on fuel efficiency of developed devices. For example, in development of fuel efficiency technique, the in-vehicle fuel management device can provide a guideline based on predictable effect on fuel efficiency, and obtain reliable results based on a simulation of various driving conditions. Further, effect on fuel efficiency about developing device can be expressed as a quantitative value. Also, influence and effect on fuel efficiency of each function, device or operation included in a vehicle can be obtained by the in-vehicle fuel management device. The in-vehicle fuel management device can also analyze the propensity of a driver, skill, and habit on operation, and calculate effect on fuel efficiency in response to the propensity of the driver, skill, and habit.

Further, a vehicle manufacturer using the in-vehicle fuel management device can reduce or save resources (e.g., time, experimental costs for development, etc.). For example, the in-vehicle fuel management device can test or predict effect on fuel efficiency, through a simulation considering a driving condition which is difficult for a vehicle test. Also, in the vehicle test, the in-vehicle fuel management device can provide an accurate effect about an analyzed function, device or operation by excluding an influence of fuel efficiency caused by other elements. Further, the in-vehicle fuel management device can support a test for fuel efficiency on a particular situation such as a coasting drive test between at least two control vehicles or an almost impossible test based on an identically repeated circumstance (e.g., excessive traffic conditions).

Further, the in-vehicle fuel management device can provide plural convenient services to a driver so as to enhance the convenience of a driver and marketability of the vehicle. For example, the in-vehicle fuel management device can provide, or support, an analyzed information about driving and fuel efficiency on every operation, an custom-made information according to the propensity of the driver such as histories about driving and fuel efficiency, drive logs/notes, and the like, and a real-time assistance or guidance for eco-driving.

Further, the in-vehicle fuel management device can be used for a vehicle level control strategies. For example, the in-vehicle fuel management device can be used for gearshift control strategies such as a gear shift schedule, a learning control reflecting driver's propensity, and the like. Also, the in-vehicle fuel management device can be applicable for control strategies in a HEV such as a ratio of EV mode and HEV mode, a charge-discharge schedule, and so on.

In the apparatus and method described above, fuel efficiency caused by each of in-vehicle functions, devices or operations can be calculated quantitatively. Then, calculated information can be provided comprehensively or selectively in response to driver's request.

Further, in development of in-vehicle functions, devices or operations for fuel efficiency, it is decomposable and understandable how each function, device or operation has an effect on fuel efficiency. Thus, reducing development resources (e.g., time, experimental costs, etc.) can be possible.

The apparatus and method described above can provide a driver with reliable information related to fuel efficiency, so as to guide him or her to drive more fuel-efficiently.

The aforementioned embodiments are achieved by combination of structural elements and features of the disclosure in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the disclosure. The order of operations described in the embodiments of the disclosure may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

Embodiments of the present disclosure may be implemented using a machine-readable medium having instructions stored thereon for execution by a processor to perform various methods presented herein. Examples of possible machine-readable mediums include a hard disk drive (HDD), a solid state disk (SSD), a silicon disk drive (SDD), ROM, RAM, CD-ROM, a magnetic tape, a floppy disk, an optical data storage device, the other types of storage mediums presented herein, and combinations thereof.

It will be apparent to those skilled in the art that various modifications and variations can be made in the present disclosure without departing from the spirit or scope of the disclosure. Thus, it is intended that the disclosure covers the modifications and variations of this disclosure provided they come within the scope of the appended claims and their equivalents.

What is claimed is:

1. An apparatus for showing information related to fuel efficiency in a vehicle, the apparatus comprising:
a determination unit collecting at least one factor related to fuel efficiency including at least one of an estimated value from a fuel economy prediction device and a travel distance under a coasting drive state;
a calculation unit obtaining a fuel efficiency ratio based on each factor and calculating a fuel gain and a fuel contribution for each factor to provide information for each factor; and
a display unit displaying the information provided from the calculation unit.

2. The apparatus according to claim 1, wherein:
the fuel economy prediction device estimates the fuel efficiency based on at least one of location information, distance information, and altitude information obtained by a global positioning system (GPS), and
the coasting drive state includes a period and a count of valid coasting drive, which are obtained by a coasting drive checking system.

3. The apparatus according to claim 2, wherein the calculation unit calculates at least one of:
a coasting drive rate, a coasting drive fuel gain, and a coasting drive fuel contribution based on the period and the count of valid coasting drive, and
an energy prediction value, an energy management fuel gain, and an energy management fuel contribution based on an estimated value delivered from the fuel economy prediction device.

4. The apparatus according to claim 1, wherein the at least one factor includes at least one of:
an economical driving section according to an engine operating state of the vehicle,
a section of an electric vehicle (EV) mode when the vehicle is a hybrid electric vehicle (HEV), and
a regenerative breaking section, performed by a regenerative braking system (RBS) of the vehicle, in which kinetic energy is extracted from braking parts of the vehicle to be stored and reused.

5. The apparatus according to claim 4, wherein the calculation unit calculates at least one of:
an eco-driving rate, an eco-driving fuel gain, and an eco-driving fuel contribution based on the economical driving section,
an EV rate, an EV fuel gain, and an EV fuel contribution based on the section of EV mode; and
an RBS rate, an RBS fuel gain, and an RBS fuel contribution based on the regenerative breaking section.

6. The apparatus according to claim 4, wherein:
the at least one factor further includes a period and a count of the regenerative breaking section checked by a regenerative breaking guidance device, and
the calculation unit calculates an RBS rate, an RBS fuel gain, and an RBS fuel contribution based on the period and the count of the regenerative breaking section.

7. The apparatus according to claim 1, wherein the at least one factor further includes at least one of:
a fuel usage consumed in at least one of an operating state of an electronic system, an ignition state, and a driving state of the vehicle based on information provided from a navigation device, and
an accumulated travel distance, a real-time fuel consumption, and an accumulated fuel consumption according to an operation state of the vehicle for a predetermined time.

8. The apparatus according to claim 7, wherein the calculation unit calculates a total travel distance, a total average speed, and a total average fuel efficiency according to the at least one factor.

9. The apparatus according to claim 1, wherein the display unit, using at least one of an instrument panel on a dashboard of the vehicle and a screen engaged with a multimedia system of the vehicle, selectively shows at least one of each information calculated by the calculation unit and comprehensive information based on the calculated information in response to a request of the driver.

10. The apparatus according to claim 1, further comprising a transceiver transferring the calculated information delivered from the calculation unit via a network.

11. The apparatus according to claim 10, wherein:
the calculation unit receives a gas price through the transceiver and applies the gas price to each calculated information and comprehensive information based on the calculated information so as to obtain fuel costs regarding each calculated information and the comprehensive information, and
the display unit displays the fuel costs in response to a request of the driver.

12. The apparatus according to claim 1, further comprising a memory storing the information for each factor provided from the calculation unit and storing history/tracking information delivered through a transceiver.

13. A network apparatus engaged with a vehicle for managing fuel efficiency, the network apparatus comprising:
a receiving unit receiving vehicle information, calculated information, and comprehensive information for at least one factor related to fuel efficiency including at least one of an estimated value and a travel distance under a coasting drive state;
a data storing unit storing the information received by the receiving unit;
a data processing unit searching for information stored in the data storing unit in response to a request received by the receiving unit and processing information identified in the data storing unit; and
a transmitting unit transmitting a result processed by the data processing unit.

14. The network apparatus according to claim 13, wherein the transmitting unit transmits a price of gas corresponding to the vehicle information via a network.

15. The network apparatus according to claim 13, wherein the at least one factor includes:
an economical driving section according to an engine operating state of the vehicle,
a section of electric vehicle (EV) mode when the vehicle is a hybrid electric vehicle (HEV),
a regenerative breaking section, performed by a regenerative braking system (RBS) of the vehicle, in which kinetic energy is extracted from braking parts of the vehicle, to be stored and reused,
a period and a count of the regenerative breaking section checked by a regenerative breaking guidance device,
a fuel usage consumed in at least one of an operating state of an electronic system, an ignition state, and a driving state of the vehicle based on information provided from a navigation device, and
an accumulated travel distance, a real-time fuel consumption, and an accumulated fuel consumption according to an operation state of the vehicle for a predetermined time.

16. An apparatus for showing information related to fuel efficiency of vehicle engaged with a network-linkable device comprising a processing system that includes at least one data processor and at least one computer-readable memory storing a computer program executable by the at least one data processor, wherein the processing system is configured to cause the apparatus to:
recognize at least one factor related to fuel efficiency including at least one of an estimated value from a fuel economy prediction device and a travel distance under a coasting drive state;
obtain a fuel efficiency ratio based on each factor, a fuel gain and a fuel contribution for each factor, and calculated information for each factor; and
display the obtained information in response to a request of a driver.

17. The apparatus according to claim 16, wherein the processing system is further configured to cause the apparatus to transmit the obtained information and the comprehensive information based on the calculated information via a network link.

18. The apparatus according to claim 16, wherein the processing system is further configured to cause the apparatus to store the obtained information for each factor, which are obtained while the vehicle operates, and history/tracking information delivered via a network link.

19. The apparatus according to claim 16, wherein the processing system is further configured to cause the apparatus to:
determine a driving route to a destination;
activate at least one of a coasting drive checking system and a fuel economy prediction device while the vehicle operates on the driving route; and
recognize at least one of a travel distance while coasting through the coasting drive checking system and a gain of state of charge (SOC) through the fuel economy prediction device.

20. The apparatus according to claim 19, wherein the processing system is further configured to cause the apparatus to:
collect information including at least one of fuel consumption during the travel distance while coasting and available gains of state of charge (SOC) while the fuel economy prediction device is enabled;
calculate the fuel gain based on the collected information;
combine the fuel gain with previous fuel gain;
estimate fuel efficiency based on the driving route and the collected information;
calculate mileage gain based on combined fuel gain and estimated fuel efficiency; and
calculate fuel contribution for each collected information based on the calculated fuel gain and the combined fuel gain.
